(19) United States
(12) Patent Application Publication
(10) Pub. No.: US 2025/0376236 A1
(43) Pub. Date: Dec. 11, 2025

(54) CROSS FRAME FOR A BICYCLE AND BICYCLE

(71) Applicant: André Armando MUFF, Kilchberg (CH)

(72) Inventor: André Armando MUFF, Kilchberg (CH)

(21) Appl. No.: 19/064,045

(22) Filed: Feb. 26, 2025

(30) Foreign Application Priority Data
Mar. 6, 2024 (EP) 24161645.7

(51) Int. Cl. B62K 3/08

(52) U.S. Cl. CPC B62K 3/08

(57) ABSTRACT

A cross frame for a bicycle, such as an e-bike, includes a head tube and a seat tube with a bottom bracket area arranged at the lower end of the seat tube, a straight first tube starting from the head tube which crosses the seat tube and then extends towards a rear dropout of a rear triangle of the cross frame, a second tube starting from the head tube above the first tube which crosses the first tube at an intersection and then extends towards the bottom bracket area, and at least one chain stay extends from the bottom bracket area to the rear dropout. The second tube has an angular deflection within the plane of the frame in the section between the head tube and the intersection to create a visually appealing frame that offers high stability and torsional rigidity with minimal weight and allows for improved handling of a bicycle equipped with the frame.

### CROSS-REFERENCE TO RELATED APPLICATIONS

This application claims priority to EP 24161645.7, filed Mar. 6, 2024, the entire contents of which is incorporated herein by reference.

### BACKGROUND OF THE INVENTION

The invention relates to a cross frame for a bicycle comprising a head tube and a seat tube with a bottom bracket area arranged at the lower end of the seat tube, a straight first tube starting from the head tube which crosses the seat tube and then extends towards a rear dropout of a rear triangle of the cross frame, and a second tube starting from the head tube above the first tube which crosses the first tube at an intersection and then extends towards the bottom bracket area.

A cross frame is a bicycle frame made up of two intersecting tubes of large diameter. This design is characterized by the crossing of two main tubes, namely the seat tube, which is extended downwards to accommodate the bottom bracket, and a tube that runs from the head tube to the rear wheel and then splits into the rear fork.

The first bicycle to have a cross frame was the “Premier” by the English company Hillman, Herbert & Cooper in 1886. These cross frames were among the first safety bicycles and were manufactured by various companies until the '90s. The cross consisted of the seat tube and a tube that ran from the head tube to the rear axle, wherein the final segment in the shape of a fork that held the rear wheel was formed therebetween. There was no down tube present.

U.S. D 335,640 discloses a generic cross frame with a straight alignment of the first and second tubes, wherein the first tube is designed as a downwardly open box profile. The box profile has a notch on its upper side at a distance from the seat tube, allowing the side walls of the box profile to split in the direction of the rear dropout of the rear triangle. At the ends of the side walls, mounts are provided for the bicycle hub axle.

FR 861 980 A discloses a cross frame with a straight alignment of the first and second tubes, wherein the rear triangle has chain stays and additional seat stays.

The cross frames known in the art have not enjoyed commercial success and their lack of stability and torsional rigidity make them unsuitable for use in bicycles with electric motors providing pedal assistance (e-bikes).

Today's e-bike frames are often unattractive and similar to one another. Most of these models prioritize cost and, to a lesser extent, functionality.

### SUMMARY OF THE INVENTION

Based on this prior art, the present invention is based on the object of creating a cross frame for a bicycle, in particular an e-bike, that is visually appealing, offers high stability and torsional rigidity with minimal weight and allows for improved handling of a bicycle equipped with the frame. Another object of the present invention is to, despite a sporty and attractive appearance, guarantee easy step-through access and accommodate the use of a bicycle equipped with the cross frame by individuals with different leg lengths.

The objects are achieved by a cross frame that consists of a head tube, a seat tube with a bottom bracket area arranged at a lower end of the seat tube, a straight first tube starts from the head tube, crosses the seat tube, and extends from the seat tube towards a rear dropout of a rear triangle of the cross frame, a second tube that starts from a position on the head tube above the first tube, crosses the first tube at an intersection, and then extends towards the bottom bracket area, the second tube exhibiting a deflection within a plane of the cross frame between the head tube and the intersection, wherein the deflection forms an obtuse angle between two deflected sections of the second tube on a side of the second tube facing the head tube, and at least one chain stay that extends from the bottom bracket area to the rear dropout.

The objects of the invention are also achieved by a bicycle having the cross frame.

The inventive frame adopts the elegant concept of the historic cross frame, incorporating a straight first tube that starts at the head tube and crosses the seat tube roughly in the middle before splitting towards the rear dropout of the rear triangle, wherein “roughly in the middle” means that the first tube crosses the seat tube within a range of +/−10 cm relative to the midpoint of the length of the seat tube. The straight first tube, sloping down to the rear dropout of the rear triangle, gives the frame, and a bicycle equipped with it, an elegant appearance.

The term “straight” refers to the alignment of the first tube as seen in the side view of a vertically oriented bicycle equipped with the cross frame according to the invention. When the first tube splits behind the seat tube, the split sections appear straight in the side view but are curved and/or angled in a plane perpendicular to the remaining part of the first tube.

High stability and torsional rigidity are achieved without compromising the elegant lines of the design by having the second tube, which starts above the first tube at the head tube, cross the first tube and then extend towards the bottom bracket area. The second tube has an angular deflection within the plane of the frame in the section between the head tube and the intersection. The term “angular deflection within the plane of the frame” describes the path of the second tube as seen in the side view of a vertically oriented bicycle equipped with the cross frame according to the invention.

By incorporating an angular deflection within the frame plane in the second tube, the bottom bracket area of a bicycle equipped with the inventive frame can be shifted towards the front wheel, while simultaneously broadening the step-through area, making it easier to mount. Shifting the bottom bracket area towards the front wheel also allows for a greater distance between the saddle and the pedals in bicycles equipped with the cross frame according to the invention, even with the same frame size. This means the same frame is also suitable for individuals with longer leg lengths.

In addition, the standover height of a bicycle equipped with the cross frame according to the invention is reduced compared with a bicycle with a similarly sized diamond frame, making the cross frame bicycle suitable for individuals with shorter leg lengths. In this case, the term “standover height” refers to the clearance space between the first tube and the crotch of a person with an extended leg while the bicycle is in a vertical position.

The rear triangle, which is subjected to significant stress due to the high drive forces in e-bikes, is stabilized by at least one chain stay extending between the bottom bracket area and the rear dropout of the rear triangle, as provided in the invention. Furthermore, the cross frame according to the invention is designed with weight reduction and a minimalist esthetic in mind, incorporating only the following tubes and stays: the head tube, the seat tube, the first and second tubes and at least one chain stay. The stability is not negatively affected by the deliberate omission of additional braces or tubes.

If only one chain stay is provided, it is preferably designed in a reinforced manner on the side of the chain or drive belt compared with the typical arrangement of two chain stays on either side of the rear wheel. If only one chain stay is provided, the first straight tube preferably extends to the rear dropout only on the same side as where the single chain stay is located. However, in a preferred embodiment with two chain stays, the straight first tube splits immediately behind the intersection with the seat tube into two straight sections extending towards the rear dropout.

The rear dropout is arranged in a torsion-resistant manner connected to the cross frame via a triangular support in conjunction with the straight alignment of the first tube. The rear dropout can be designed as a separate component, integrally connecting the at least one chain stay and the first tube.

In addition to its high stability, the inventive design of the cross frame also offers advantages for series production. This is due to reduced tooling costs and shorter production times, particularly when the cross frame according to the invention is made from fiber-reinforced materials or plastic processed using the injection molding method.

The measures provided by the invention not only improve the stability and torsional rigidity of the frame, but also enhance the handling of a bicycle equipped with it, particularly its steering behavior.

The two tubes extending from the head tube may initially run almost parallel to each other (either diverging or converging) before the second tube crosses the first tube in the front half of the section between the head tube and the seat tube. When the angle of deflection of the second tube is approximately between 90° and 170°, preferably 160°, the second tube, along with the section of the first tube up to the intersection between the first and second tubes, forms a characteristic F-design.

If the cross section of the second tube is larger than that of the first tube, this not only contributes to stabilizing the frame, particularly in the bottom bracket area where the motor of an e-bike is typically located, but also allows for the visually appealing integration of the necessary battery into this second tube with the enlarged cross section.

Regardless of whether the inventive frame is made from metallic materials (particularly aluminum), plastic, carbon or fiber-reinforced composites, the tubes are integrally connected at the intersections between the first tube and the seat tube, as well as between the first and second tubes. Similarly, the chain stays are connected in a form-fitting manner.

In an advantageous embodiment of the invention, the angular transitions at the deflection are rounded. Rounding these transitions positively affects the stability of the cross frame, in particular by reducing stress peaks at the deflection, thereby increasing the overall stability of the frame.

### BRIEF DESCRIPTION OF THE DRAWINGS

The cross frame according to the invention will be described in greater detail below with reference to the figures. In the drawings,

FIG. 1 is a side view of an e-bike equipped with a cross frame according to an embodiment of the present invention,

FIG. 2a is a side view of the cross frame according to an embodiment of the invention and

FIG. 2b is a plan view of the cross frame according to FIG. 2a.

### DETAILED DESCRIPTION OF THE PREFERRED EMBODIMENTS

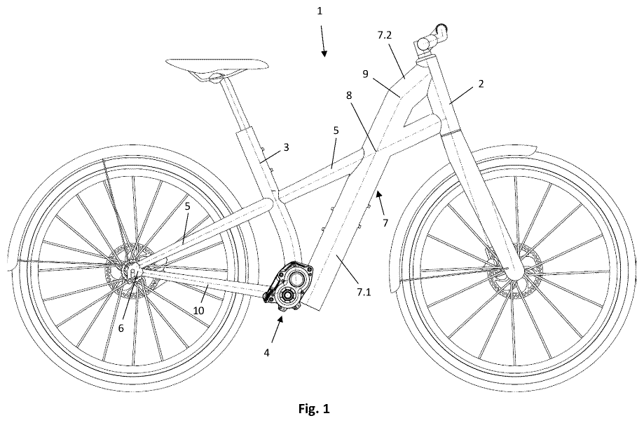

FIG. 1 shows a bicycle with a cross frame 1 according to the invention, comprising a head tube 2 and a seat tube 3 with a bottom bracket area 4 arranged at the lower end of the seat tube 3. In an e-bike, the electric drive system is arranged in the bottom bracket area 4.

A straight first tube 5 starts at the bottom of the head tube 2, crossing the seat tube 3 roughly in the middle and then splitting towards the rear dropout of the rear triangle 6. The uniformly sloping line from the head tube 2 to the rear dropout 6 creates a very elegant frame design.

Above the first tube 5, a second tube 7 with a substantially larger cross section is connected to the head tube 2. The second tube 7 crosses the first tube 5 in the front half of the section between the head tube 2 and the seat tube 3 and then extends to the bottom bracket area 4.

The second tube 7 includes a deflection 9 within the plane of the frame in the section 7.2 between the head tube 2 and the intersection 8, the deflected sections 7.1 and 7.2 of the second tube 7 forming an obtuse angle on the side facing the head tube 2.

Finally, the cross frame 1 according to the invention has two chain stays 10 that extend from the bottom bracket area 4 to the rear dropout 6.

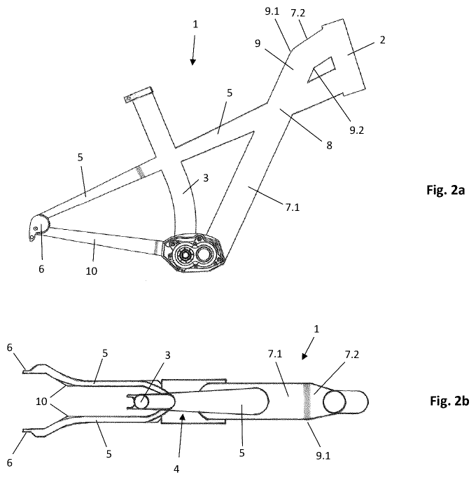

From the plan view of the cross frame in FIG. 2b, it can be seen that the straight first tube 5 splits above the two chain stays 10 immediately behind the intersection with the seat tube 3 and extends towards the rear dropout 6.

From the side view of the cross frame according to FIG. 2a, it is clear that the angular transitions 9.1 and 9.2 at the deflection 9 are rounded, to further enhance the stability of the cross frame.

List of reference signs

| | |
|---|---|
| 1 | cross frame |
| 2 | head tube |
| 3 | seat tube |
| 4 | bottom bracket area |
| 5 | first tube |
| 6 | rear dropout of the rear triangle |
| 7 | second tube |
| 7.1 | section |
| 7.2 | section |
| 8 | intersection |
| 9 | deflection |
| 9.1 | angular transition |
| 9.2 | angular transition |
| 10 | chain stays |

1. A cross frame for a bicycle, consisting of:
a head tube;
a seat tube with a bottom bracket area arranged at a lower end of the seat tube;
a straight first tube starts from the head tube, crosses the seat tube, and extends from the seat tube towards a rear dropout of a rear triangle of the cross frame,
a second tube that starts from a position on the head tube above the first tube, crosses the first tube at an intersection, and then extends towards the bottom bracket area, the second tube exhibiting a deflection within a plane of the cross frame between the head tube and the intersection, wherein the deflection forms an obtuse angle between two deflected sections of the second tube on a side of the second tube facing the head tube; and
at least one chain stay that extends from the bottom bracket area to the rear dropout.

2. The cross frame according to claim 1, wherein the second tube crosses the first tube in a front half of a section of the first tube between the head tube and the seat tube.

3. The cross frame according to claim 1, wherein the obtuse angle is less than 170°.

4. The cross frame according to claim 1, wherein the first tube crosses the seat tube at a position within a range of +/−10 cm relative to a midpoint of a length of the seat tube.

5. The cross frame according to claim 1, wherein a cross section of the second tube is larger than a cross section of the first tube.

6. The cross frame according to claim 1, wherein
the first tube and the second tube are integrally connected at the intersection, and
the first tube and the seat tube are integrally connected where the first tube crosses the seat tube.

7. The cross frame according to claim 1, wherein the cross frame is constructed using fiber-reinforced composites.

8. The cross frame according to claim 1, wherein angular transitions at the deflection are rounded.

9. The cross frame according to claim 1, wherein the straight first tube splits immediately behind the seat tube and extends towards the rear dropout.

10. A bicycle with a cross frame according to claim 1.
